(19) United States
(12) Patent Application Publication
(10) Pub. No.: US 2002/0073688 A1
(43) Pub. Date: Jun. 20, 2002

(54) Annular recuperator

(76) Inventors: Robert W. Bosley, Cerritos, CA (US); Yungmo Kang, La Canada, CA (US)

Correspondence Address: IRELL & MANELLA LLP, Suite 900, 1800 Avenue of the Stars, Los Angeles, CA, 90067, US

(21) Appl. No.: 09/971,874

(22) Filed: Oct. 4, 2001

Related U.S. Application Data
(60) Provisional application No. 60/246,682, filed on Nov. 7, 2000.
(60) Provisional application No. 60/250,860, filed on Dec. 1, 2000.

(51) Int. Cl. F02C 7/10

(52) U.S. Cl. 60/39.511; 29/890.03

(57) ABSTRACT

A annular recuperator to recover waste heat from a gas turbine exhaust in order to preheat the compressed air delivered to the gas turbine combustor, formed with gas flow passages for the relatively hot turbine exhaust gases and air flow passages for the relatively cool compressed air separated by thin, thermally conductive metal foil barriers. The flow passages have contoured gaps between the foil surfaces in order to establish the desired air/gas aerodynamic friction induced pressure drop and mass flow profiles within the recuperator core. The gaps are set by an array of dimples in the metal foil barriers with each dimple having a precisely controlled height. The metal foil barriers are formed by first dimpling and then bending a single sheet metal strip to form a convoluted foil structure that is wrapped around an inner cylinder and the ends joined. An outer cylinder is then installed around the wrapped, convoluted foil barrier structure. The ends of the foil strips are welded closed and the turbine exhaust gas flow passages are left open at the ends. The inlet and outlet ports for the compressed air are formed in the opposite ends of the inner cylinder to face radially and the turbine exhaust gases enter and exit axially at the opposite ends of the core.

### RELATED APPLICATIONS

This patent application claims the priority of provisional patent applications serial No. 60/246,682, filed Nov. 7, 2000 and serial No. 60/250,860, filed Dec. 1, 2000.

### STATEMENT REGARDING FEDERALLY SPONSORED DEVELOPMENT

The U.S. Government has a paid-up license in this invention and the right in limited circumstances to require the patent owner to license others on reasonable terms as provided for by the terms of the Advanced MicroTurbine System Contract NO. DE-FC02-01CH11058 awarded by the Department of Energy.

### BACKGROUND OF THE INVENTION

A turbogenerator electric power generation system is generally comprised of a compressor, a combustor including fuel injectors and an ignition source, a turbine, and an electrical generator. Often, the system includes a recuperator to preheat combustion air with waste heat from the turbine exhaust. The ability of the recuperator to transfer waste heat from the exhaust to the combustion air can significantly impact the efficiency of the turbogenerator system, and an efficient recuperator can substantially lower system fuel consumption. Therefore, what is needed is a recuperator for a turbogenerator system to efficiently transfer heat from turbine exhaust gas to combustion air.

### BRIEF SUMMARY OF THE INVENTION

The present invention meets the above need by providing, in one aspect, an annular recuperator for transferring heat from a hot fluid stream to a cool fluid stream, comprising a generally cylindrical annular housing having an inner wall, an outer wall, and axially opposed first and second ends defined between the inner wall and the outer wall, and a single elongated sheet of material formed in a continuous serpentine pattern of surfaces extending between the inner wall and the outer wall to define a plurality of fluid flow channels therebetween extending from the first end to the second end, the surfaces formed with protrusions extending therefrom to abut an adjacent surface.

In a further aspect, the present invention provides a method to construct an annular recuperator for transferring heat from a hot fluid stream to a cool fluid stream, comprising disposing a generally cylindrical inner wall within a generally cylindrical outer wall to define axially opposed first and second ends therebetween, providing an elongated sheet of material, forming protrusions extending from both sides of the sheet, folding the sheet into a serpentine pattern of facing surfaces, and disposing the folded sheet between the walls with the surfaces extending between the inner wall and the outer wall to define a plurality of fluid flow channels therebetween extending from the first end to the second end, each protrusion abutting an adjacent surface.

In another aspect of the invention, the fluid flow channels form alternating cold channels for the cool fluid stream and hot channels for the hot fluid stream, and the recuperator also comprises a plurality of inlets formed in the inner wall at the first end and in fluid communication with the cold channels to admit the cool fluid stream therein, and a plurality of outlets formed in the inner wall at the second end and in fluid communication with the cold channels to allow the cool fluid stream to exit therefrom. Every pair of surfaces defining a cold channel therebetween may be joined together along their edges extending from the inner wall to the outer wall to form a fluid seal along each edge. One or more of the protrusions may abut a like protrusion extending from an adjacent surface, or may abut the adjacent surface.

### BRIEF DESCRIPTION OF THE DRAWINGS

FIG. 1 is perspective view, partially in section, of a turbogenerator system with an annular recuperator according to the present invention;

FIG. 2 is a diagram showing in cross section the spacing and placement of cold and hot channels in the annular recuperator of FIG. 1;

FIG. 3 is a enlarged detailed view of cold and hot channels in the annular recuperator of FIG. 2;

FIG. 4(a) is a perspective view of a sheet of material for forming the annular recuperator of FIG. 2;

FIG. 4(b) is a front view of the sheet of material of FIG. 4(a);

FIG. 5 is a side view of the sheet of material of FIG. 4(a) formed into a serpentine convolute pattern, with some of the dimensions exaggerated to show detail;

FIG. 6 is a side view of a cold channel formed by the convoluted sheet of FIG. 5;

FIG. 7 is a perspective view of an inner wall used with the recuperator of FIG. 2;

FIG. 8 is an enlarged front view of a recuperator core formed with the convolute sheet of FIG. 5;

FIG. 9 is an enlarged view showing a radially outer section of the recuperator core of FIG. 8;

FIG. 10 is an enlarged view showing a radially inner section of the recuperator core of FIG. 8;

FIG. 11 is an enlarged view of the radially outer section shown in FIG. 9;

FIG. 12 is an enlarged front view showing the radially inner section of the recuperator core of FIG. 10 disposed over the inner wall of FIG. 7;

FIG. 13 is a front view of the sheet of material of FIG. 4 showing the dimples formed therein;

FIG. 14 is a side view, in section, taken along line 14-14 of FIG. 13;

FIG. 15 is a side view, in section, taken along line 15-15 of FIG. 13;

FIG. 16 is an enlarged perspective view of a section of the sheet of material of FIG. 13;

FIG. 17 is an enlarged perspective view of a section of the sheet of material of FIG. 13 showing a single dimple;

FIG. 18 is a front view of the sheet of material of FIG. 13 showing the dimple pattern near a cold channel outlet;

FIG. 19 is a sectional view of the recuperator core taken along line L-L of FIG. 8;

FIG. 20 is a sectional view of the recuperator core taken along line M-M of FIG. 8;

FIG. 21 is a sectional view of the recuperator core taken along line N-N of FIG. 8;

FIG. 22 is a sectional view of the recuperator core taken along line O-O of FIG. 8;

FIG. 23 is a sectional view of the end of a cold and a hot channel, near the axial end area of the recuperator core of FIG. 8, shown without dimples; and

FIG. 24 is a sectional view of the end of a cold and a hot channel, near the axial center area of the recuperator core of FIG. 8, shown without dimples.

### DETAILED DESCRIPTION OF THE INVENTION

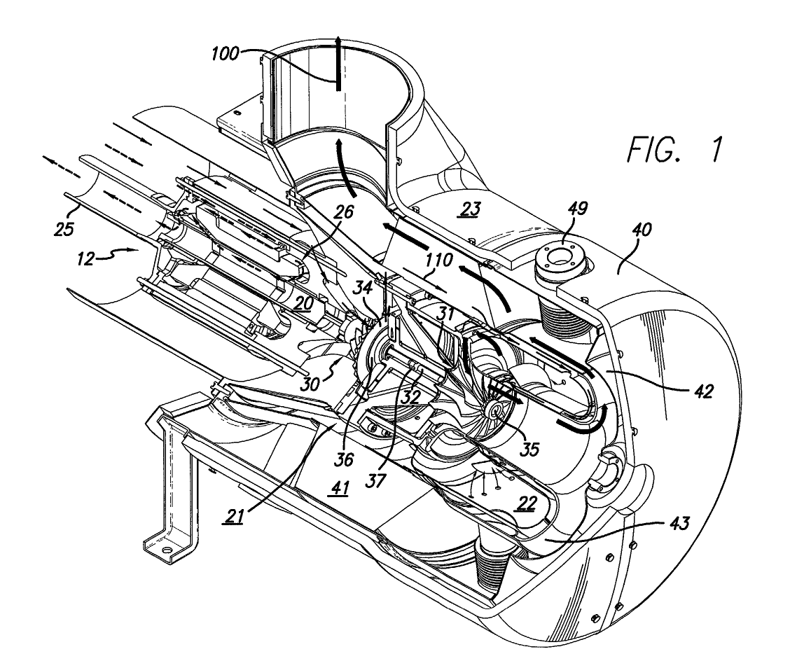

Referring to FIG. 1, integrated turbogenerator system 12 generally includes generator 20, power head 21, combustor 22, and recuperator (or heat exchanger) 23. Power head 21 of turbogenerator 12 includes compressor 30, turbine 31, and bearing rotor 32. Tie rod 33 to magnetic rotor 26 (which may be a permanent magnet) of generator 20 passes through bearing rotor 32. Compressor 30 includes compressor impeller or wheel 34 that draws air flowing from an annular air flow passage in outer cylindrical sleeve 29 around stator 27 of the generator 20. Turbine 31 includes turbine wheel 35 that receives hot exhaust gas flowing from combustor 22. Combustor 22 receives preheated air from recuperator 23 and fuel through a plurality of fuel injector guides 49. Compressor wheel 34 and turbine wheel 35 are supported on bearing shaft or rotor 32 having radially extending air-flow bearing rotor thrust disk 36. Bearing rotor 32 is rotatably supported by a single air-flow journal bearing within center bearing housing 37 while bearing rotor thrust disk 36 at the compressor end of bearing rotor 32 is rotatably supported by a bilateral air-flow thrust bearing.

Generator 20 includes magnetic rotor or sleeve 26 rotatably supported within generator stator 27 by a pair of spaced journal bearings. Both rotor 26 and stator 27 may include permanent magnets. Air is drawn by the rotation of rotor 26 and travels between rotor 26 and stator 27 and further through an annular space formed radially outward of the stator to cool generator 20. Inner sleeve 25 serves to separate the air expelled by rotor 26 from the air being drawn in by compressor 30, thereby preventing preheated air from being drawn in by the compressor and adversely affecting the performance of the compressor (due to the lower density of preheated air as opposed to ambient-temperature air).

In operation, air is drawn through sleeve 29 by compressor 30, compressed, and directed to flow into recuperator 23. Recuperator 23 includes annular housing 40 with heat transfer section or core 41, exhaust gas dome 42, and combustor dome 43. Heat from exhaust gas 110 exiting turbine 31 is used to preheat compressed air 100 flowing through recuperator 23 before it enters combustor 22, where the preheated air is mixed with fuel and ignited such as by electrical spark, hot surface ignition, or catalyst. The fuel may also be premixed with all or a portion of the preheated air prior to injection into the combustor. The resulting combustion gas expands in turbine 31 to drive turbine impeller 35 and, through common shaft 32, drive compressor 30 and rotor 26 of generator 20. The expanded turbine exhaust gas then exits turbine 31 and flows through recuperator 23 before being discharged from turbogenerator 12.

Recuperator 23 receives, channels, and transfers heat from hot fluid stream 100 (comprised of the turbine exhaust gas) to cool fluid stream 110 (comprised of the compressed air from compressor 30). To increase its efficiency, recuperator 23 maximizes the thermal intermixing of the two streams while keeping the streams physically separate and also minimizing the flow resistance encountered by the two streams. Recuperator 23 thus includes a plurality of low temperature, high pressure “cold” passages or channels disposed adjacent to high temperature, low pressure “hot” passages or channels in an alternating pattern repeated over the entire diameter of the recuperator core.

As discussed below in detail, the present invention recognizes that a problem to be solved for providing an efficient recuperator is matching the cold, high-pressure fluid flow to the hot, low-pressure fluid flow throughout the recuperator maximize the amount of heat energy transferred to the cool fluid stream (e.g. combustion air) from the hot fluid stream (e.g. the turbine exhaust). This entails promoting evenly distributed fluid mass flows throughout the recuperator in both the cold channels and the hot channels. As detailed below, conventional designs typically promote evenly distributed mass flow through the hot channels but not in the cold channels.

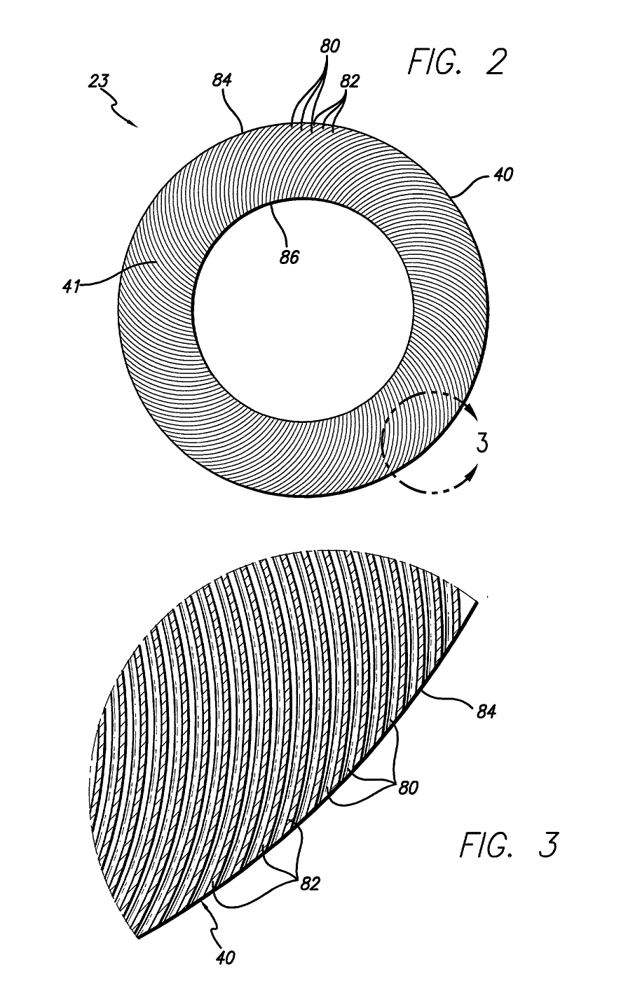

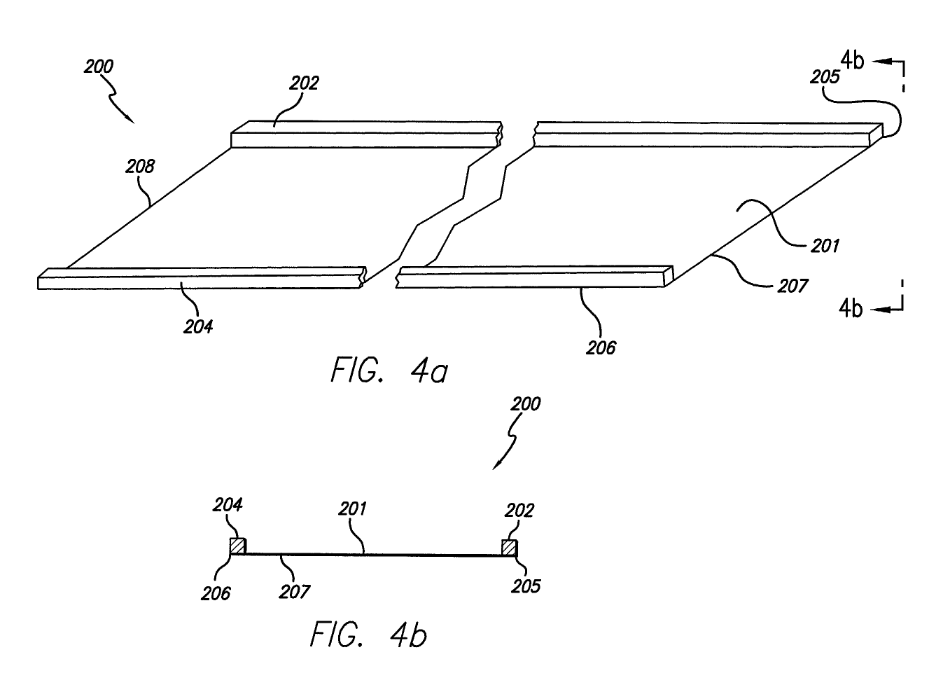

Referring to FIG. 2 and FIG. 3, recuperator core 41 is shown in greater detail as formed of alternating cold channels 80 and hot channels 82 disposed in an annular pattern defined by outer annulus 84 and inner annulus 86. Outer annulus 84 corresponds to annular housing 40 of recuperator 23. Referring to FIG. 4, in a preferred method of construction of annular recuperator 23, metal sheet 200 has elongated generally rectangular surface 201 defined by parallel, longer edges 205 and 206 and parallel, shorter edges 207 and 208, and formed with longitudinally extending lips 202 and 204 along each of longer sides 205 and 206, respectively. Lips 202 and 204 may be formed by folding or bending sheet 200, or welding material, or any other practicable method, and both extend toward the same direction from surface 201.

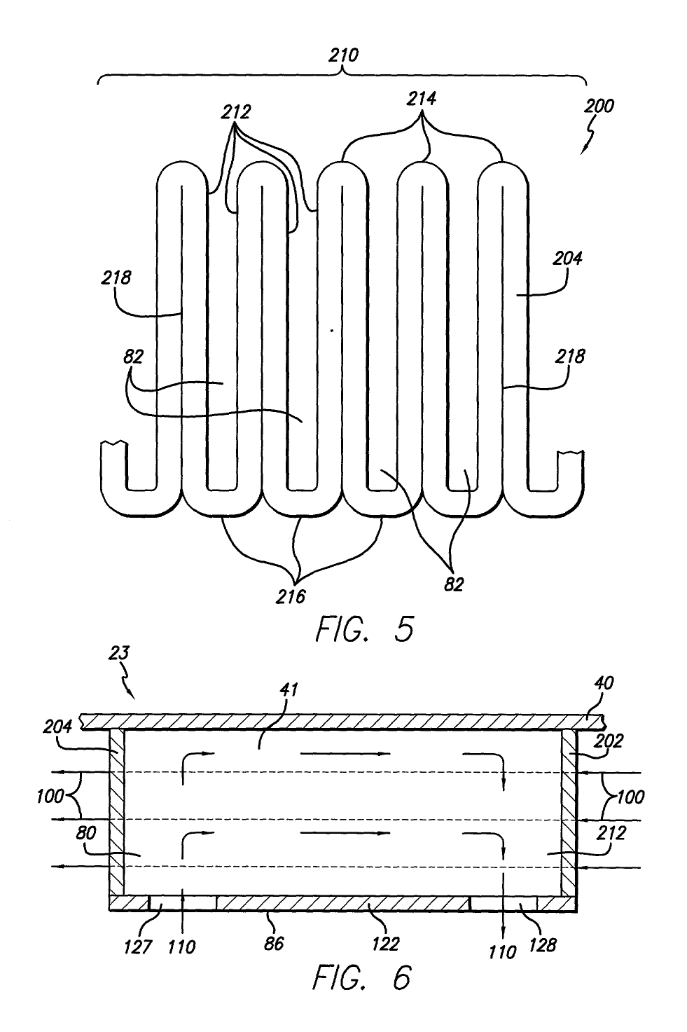

Referring to FIG. 5, sheet 200 is folded into a convolute or serpentine pattern 210 with facing surfaces 212 connected to each of the two adjacent surfaces 212 along outer edges 214 and inner 216 respectively, and formed into the annular shape of recuperator core 41 with inner edges 216 abutting inner annulus 86 (as shown in FIG. 2) and shorter edges 207 and 208 connected to one another (such as by welding). Surfaces 212 define therebetween hot channels 82 alternating with cold channels 80 and, because they extend toward the same direction from surface 201, lips 202 and 204 abut themselves along radially extending edges 218 to seal off the longitudinal ends of the cold channels. In a preferred method of fabrication lips 202 and 204 are pinched and/or welded to form an air-tight seal. Hot channels 82 are defined between facing surfaces 212 with open longitudinal ends to accept exhaust gas 100 (as shown in FIG. 1) to flow therethrough.

Referring again to FIGS. 2 and 3, channels 80 and 82 may be formed with a generally rectangular cross section and thereafter may be molded into a generally arcuate configuration. This arcuate configuration allows both cold and hot channels to maintain a relatively constant cross section along their radial length. As discussed elsewhere, protrusions extending from cold channels 80 through hot channels 82 (shown in FIGS. X-Y) space surfaces 212 apart as well as direct fluid flow through the channels. Outer edges 214 of cold channels 80 abut annular housing 40 but are typically not connected to the housing to be able to move with respect to the housing as may be necessitated by thermal expansion and contraction. Inner edges 216 are preferably welded to inner annulus 86.

Referring to FIG. 6, core 41 of recuperator 23 is bounded by outer annular housing 40 and inner cylinder 122 defining inner annulus 86. As also shown in FIG. 7, inner cylinder 122 is formed with high pressure inlets 127 and high pressure outlets 128. Recuperator core is disposed such that each cold channel 80 is in fluid communication with one high pressure inlet 127 and one high pressure outlet 128 to allow high pressure cool fluid stream 100 to flow therethrough. Referring to FIG. 7, both high pressure inlets 127 and high pressure outlets 128 may be formed, in one embodiment, by axially slitting or slicing inner cylinder 122 and then bending the sliced material to form louvers 131 and 132, respectively. In operation, high-pressure cool fluid stream 100 exits compressor 30 and enters cold channels 80 through inlet 127, travels along the axial length of the cold channels, and eventually exits through outlets 128. In a preferred embodiment, hot fluid stream 110 flows through hot channels 82 in the opposite to cool fluid stream 100. Hot channels 82 are formed with completely open axial ends, and thus hot fluid stream 100 is substantially evenly distributed throughout each hot channel.

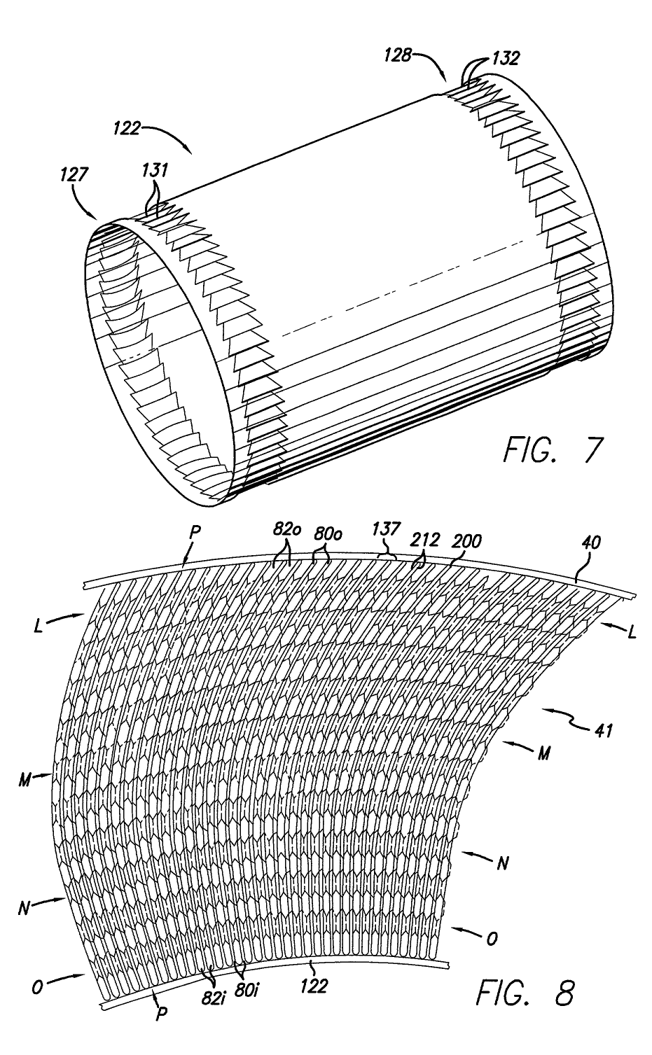

Referring to FIG. 8, cold channels 80 and hot channels 82 at the outer diameter (near outer annulus 84) of recuperator core 41 are designated as 80o and 82o respectively while at the inner diameter (near inner annulus 86) are designated 80i and 82i, respectively. One cold channel 80 together with an adjacent hot channel 82 is considered to comprise a recuperator core cell 137. The recuperator core 41 may include as many as five hundred cells 137.

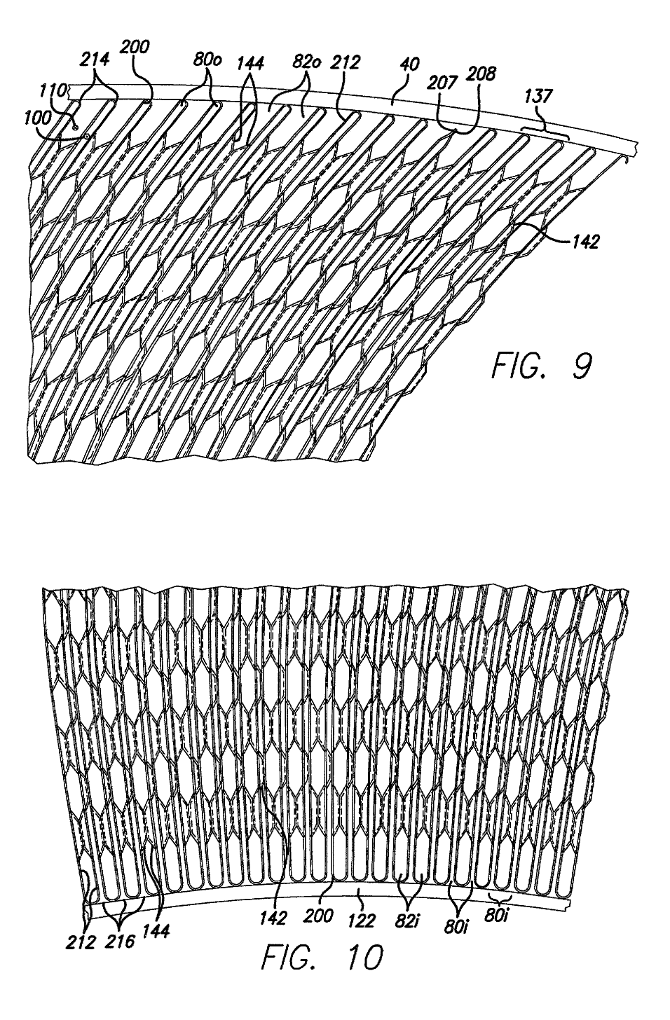

Referring to FIG. 9, the outer diameter of recuperator core 41 is shown in enlarged detail. FIG. 10 shows the inner of recuperator core 41 in enlarged detail. Referring to FIG. 11, and as previously mentioned, opposite shorter edges 207 and 208 of sheet 200 are joined together to close serpentine pattern 210 of sheet 200 into a continuous pattern and to form air-tight seal 140 between hot fluid flow 100 and cold fluid flow 110. Similarly, lips 202 and 204 extending along longer edges 205 and 206, respectively, are also joined together (to themselves) at each axial end, respectively, of each cold channel 80 to form air-tight seal 139 between hot fluid flow 100 and cold fluid flow 110. Forming seal 139 also has a pinching effect on the cross section of the cold channels, thereby in effect widening the hot channel inlets and outlets to reduce turbulence and promote even mass flow throughout the hot channels.

With continued reference to FIGS. 8-11, the spacing in cold channels 80 is maintained by plurality of cold channel dimples 142 on one side of each surface 212. Dimples 142 extend from one surface 212 to contact the adjacent surface 212 to maintain cold channel spacing. The spacing in hot channels 82 is established by plurality of opposed hot channel dimples 144 extending from each surface 212 away from cold channel dimples 142, with each dimple 144 from one surface 212 contacting a corresponding dimple 144 from the adjacent surface 212. Hot channel dimples 144 serve to stabilize surfaces 212 against the crushing force caused by the pressure difference between the cold, high-pressure channels and the hot, low-pressure channels. Using pairs of abutting hot channel dimples 144 provides superior strength to using a single, larger dimple. Additionally, because hot channel dimples 144 are smaller and thus have a smaller footprint, cold channel dimples 142 can be disposed between hot channel dimples 144 to provide superior structural strength and fluid flow distribution.

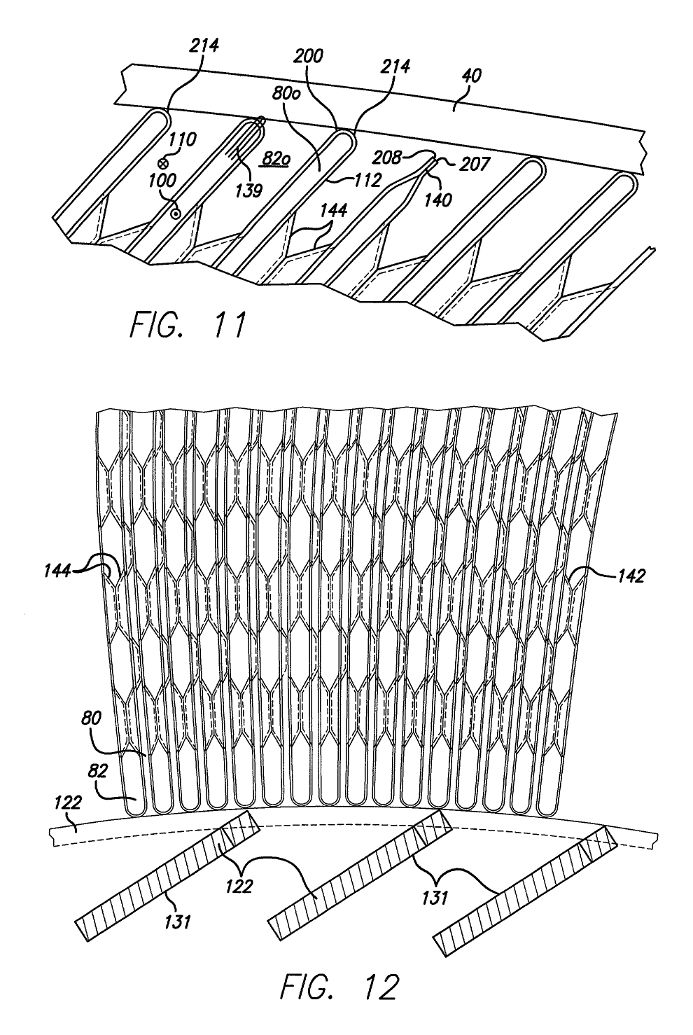

Referring to FIG. 12, an enlarged view of the high pressure inlet end of recuperator core 41 shows the positioning of louvers 131 formed in inner cylinder 122 at high pressure inlet 127. Louvers 132 forming high pressure outlet 128 (as shown in FIG. 7) are similarly formed and disposed.

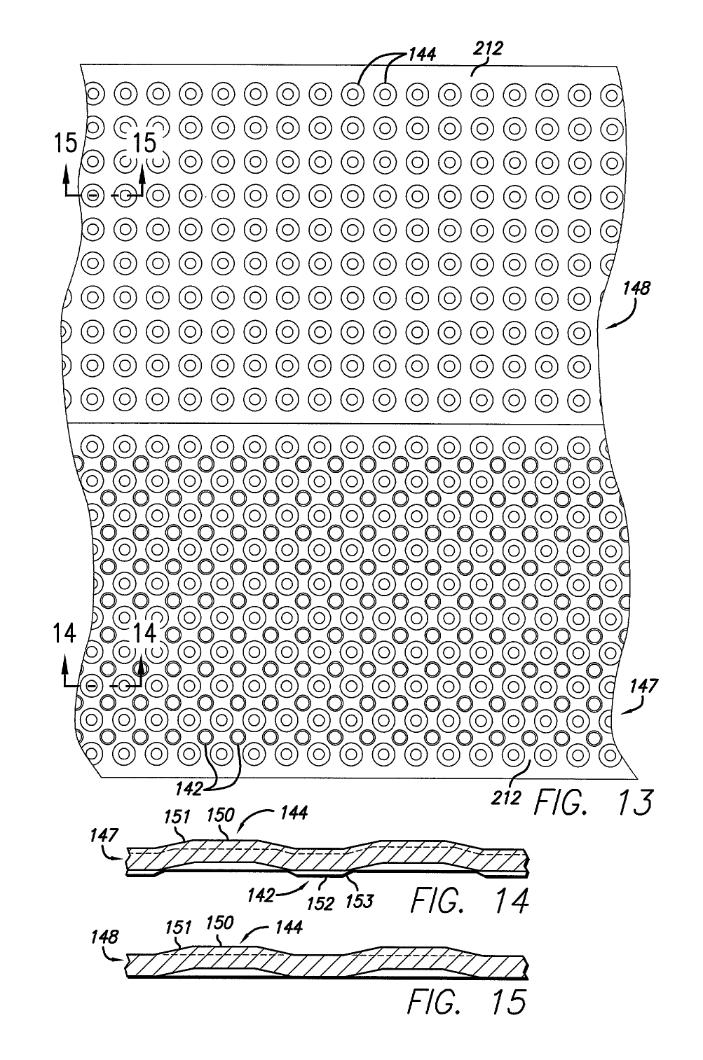

Referring to FIGS. 13-15, sheet 200 is bent to form cold channels 80 and hot channels 82 and is further formed with cold channel dimples 142 and hot channel dimples 144 to define alternating double dimpled sections 147 and single dimpled sections 148. FIGS. 13-15 depict the axial central section of recuperator core 41. The positioning and spacing of hot channel dimples 144 in the axial central section of core 41 are generally the same along the axial length of this section since the central section is removed from high pressure inlet 127 and high pressure outlet 127. Double dimpled section 147 includes hot channel dimples 144 extending from surface 212 in one direction and cold channel dimples 142 extending from surface 212 in the other direction. Single sided dimpled section 148 includes hot channel dimples 144 extending from surface 212 in only one direction.

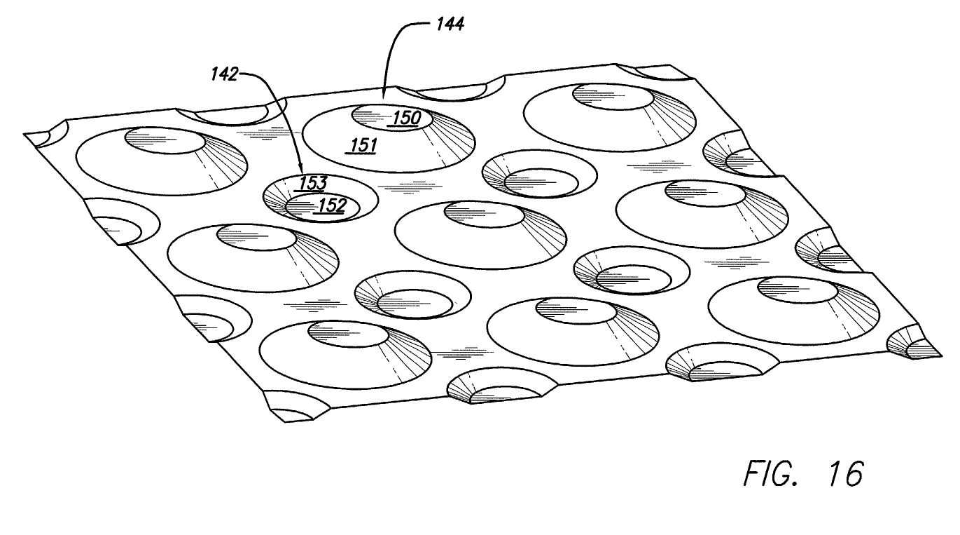

Referring to FIGS. 16-18, a portion of the central area of a double dimpled section 147 is illustrated. FIG. 16 depicts an area of nine hot channel dimples 144 with at least portions of sixteen cold channel dimples 142 also shown. In FIG. 17, an enlarged single hot channel dimple 144 is shown amongst four cold channel dimples 142.

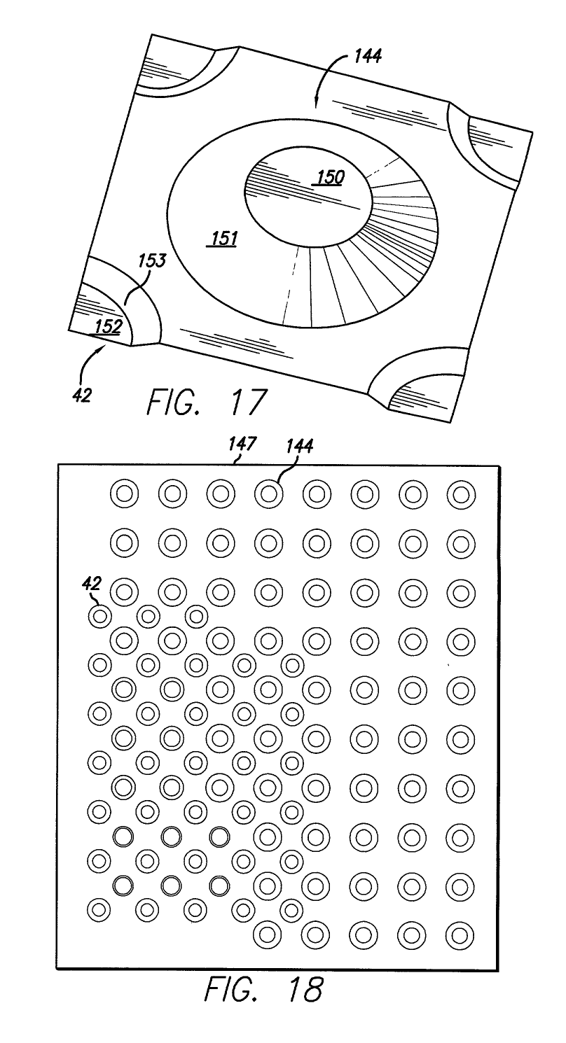

The outlet section end of a single dimpled section 148 is shown in FIG. 18 and generally illustrates the relative positions of hot channel dimples 144 and cold channel dimples 142 on opposite sides of sheet 200 in this area. The outlet section end of a single dimpled section 148 includes both upwardly projecting hot channel dimples 144 and downwardly projecting cold channel dimples 142. The cold channel dimples 142 at both the outlet end and the inlet end of single dimpled section 148 serve to form a weir to slow the flow of high pressure fluid 110 from simply moving down recuperator core 41 adjacent to inner cylinder 122 and to encourage the high pressure fluid to travel radially to and from the outer diameter area of the recuperator core near outer annular housing 40. Selecting the sizing and distribution of the dimples appropriately thus promotes more evenly distributed fluid mass flows through the cold and hot channels and can be used to direct mass flow from areas of high flow concentration (e.g. near inner cylinder 122) towards areas of lower flow concentration (e.g. near annular housing 40).

Through the axial center area of recuperator core 41, the height of hot channel dimples 144 is axially constant but increases radially outwardly to account for the increasing cross-sectional area of the channels in the radially outward direction. At the axial end of the core, the height of the hot channel dimples is also axially constant but at a lower height that in the axial center area of the recuperator core. Downwardly projecting cold channel dimples 142 are introduced in the axial end area and vary in height radial but are axially constant in height except for the axially innermost column which has less height.

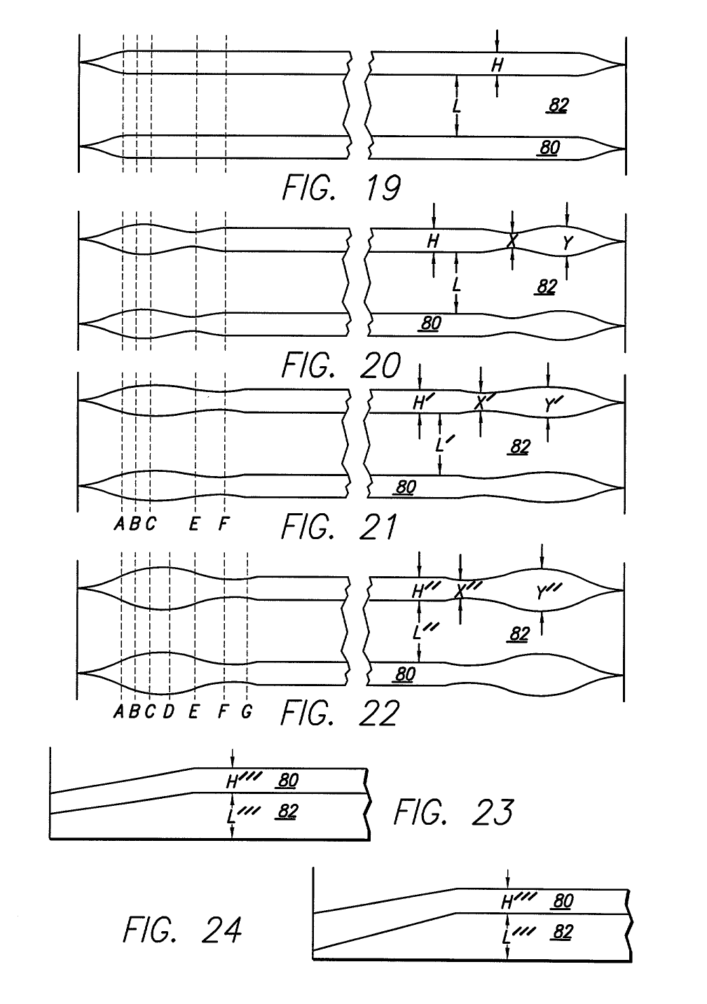

FIGS. 19-22 depict cold channels 80 and hot channels 82 (with the dimples not shown) at different diameters in the recuperator core 41. FIG. 19 is a sectional view of the core generally illustrating the hot and cold channels near the outer diameter of the recuperator along line L-L of FIG. 8. The channels near the center diameter of the recuperator along line M-M of FIG. 8 are illustrated in FIG. 20. FIG. 21 is generally illustrating the channels between the center diameter and the inner diameter of the recuperator along line N-N of FIG. 8 while the channels near the inner diameter of the recuperator along line O-O of FIG. 8 are shown in FIG. 22.

At both the outer diameter positions of FIG. 19 and the central diameter positions of FIG. 20, gap H of cold channels 80 are generally the same as are gaps L in hot channels 82. While high pressure passage gap H reaches this gap at line A, high pressure gap H in the central diameter position reaches this gap at line F. The central diameter position high pressure gap reaches its greatest gap Y at line B and its narrowest gap X at line E. Line B is displaced farther inward from the end of the core than line A.

The greatest high pressure passage gap Y′ in the diameter between the central diameter position and the inner diameter position is at line C while the narrowest gap X′ is at line F. Line C is further displaced inward from line B while line F is also displaced inward from line E. The greatest gap Y″ at the inner diameter position high pressure gap is at line D, while the narrowest gap X″ is at line G, with line D displaced inward from line C and line G displaced inward from line F.

The axial distance between lines A, B, C, and D may be generally the same. The axial distance between lines E, F, and G may likewise be the same but normally would be about twice the distance between lines A, B, C, and D. While gaps H and L of cold channels 80 and hot channels 82 respectively may generally be the same for the outer and central diameter positions, gaps H′ of the diameter position between the central diameter position and the inner diameter position would normally be less than gap H with gap H″ of the inner diameter position being less than H′. L′ is also less than L, and L″ is less than L′. H′+L′ can be about eighty-five percent of H+L, while H″+L″ can be about seventy percent of H+L.

Referring to FIGS. 23 and 24, cold channels 80 and hot channels 82 are shown without the dimples and are both formed with tapered end sections at both inner cylinder 122 and outer annular housing 40. This taper is greater at the axial end area of the core as best illustrated in FIG. 24. Hot channels 82 are more restricted at the axial end area of the core than in the axial center area of the core.

Although the invention has been described with reference to particular embodiments, these embodiments are offered merely for illustration and ease of discussion of the general inventive concept. Numerous modifications and additions may be made to the embodiments described herein without departing from the scope and spirit of the invention. Thus, the invention may used with any other fluid capable of carrying heat, and is not limited solely to air or solely to gases. Practice of the invention is also not limited solely to counterflow recuperator designs.

Having now described the invention in accordance with the requirements of the patent statutes, those skilled in the art will understand how to make changes and modifications to the disclosed embodiments to meet their specific requirements or conditions. Such changes and modifications may be made without departing from the scope and spirit of the invention, as defined and limited solely by the following claims.

What is claimed is:

1. An annular recuperator for transferring heat from a hot fluid stream to a cool fluid stream, comprising:
a generally cylindrical annular housing having an inner wall, an outer wall, and axially opposed first and second ends defined between the inner wall and the outer wall; and
a single elongated sheet of material formed in a continuous serpentine pattern of surfaces extending between the inner wall and the outer wall to define a plurality of fluid flow channels therebetween extending from the first end to the second end, the surfaces formed with protrusions extending therefrom to abut an adjacent surface.

2. The annular recuperator of claim 1, wherein the fluid flow channels form alternating cold channels for the cool fluid stream and hot channels for the hot fluid stream, and comprising:
a plurality of inlets formed in the inner wall at the first end and in fluid communication with the cold channels to admit the cool fluid stream therein; and
a plurality of outlets formed in the inner wall at the second end and in fluid communication with the cold channels to allow the cool fluid stream to exit therefrom.

3. The annular recuperator of claim 2, wherein every pair of surfaces defining a cold channel therebetween are joined together along their edges extending from the inner wall to the outer wall to form a fluid seal along each edge.

4. The annular recuperator of claims 1, 2 or 3, wherein the protrusions extending through a cold channel abut the adjacent surface.

5. The annular recuperator of claim 4, wherein the protrusions are formed with a generally frustoconical configuration.

6. The annular recuperator of claims 1, 2 or 3, wherein the protrusions extending through a hot channel each abut a like protrusion extending from the adjacent surface.

7. The annular recuperator of claim 4, wherein the protrusions are formed with a generally frustoconical configuration.

8. The annular recuperator of claim 6, wherein the protrusions extending through a hot channel each abut a like protrusion extending from the adjacent surface.

9. The annular recuperator of claim 8, wherein the protrusions are formed with a generally frustoconical configuration.

10. The annular recuperator of claim 2, wherein the protrusions are distributed on each surface to promote even mass distribution of the fluid streams throughout the channels.

11. The annular recuperator of claim 10, wherein the protrusions extending through the cold channels are distributed with greater density near the inlets to promote increased cool fluid flow in the radial direction.

12. The annular recuperator of claims 10 or 11, wherein the protrusions extend from the surfaces to varying distances to promote even mass distribution of the fluid streams throughout the channels.

13. The annular recuperator of claim 12, wherein the protrusions define channels having varying cross-sectional areas to promote even mass distribution of the fluid streams throughout the channels.

14. The annular recuperator of claim 13, wherein the cold channels have radially increasing cross-sectional area.

15. A method to construct an annular recuperator for transferring heat from a hot fluid stream to a cool fluid stream, comprising:
disposing a generally cylindrical inner wall within a generally cylindrical outer wall to define axially opposed first and second ends therebetween;
providing an elongated sheet of material;
forming protrusions extending from both sides of the sheet;
folding the sheet into a serpentine pattern of facing surfaces; and
disposing the folded sheet between the walls with the surfaces extending between the inner wall and the outer wall to define a plurality of fluid flow channels therebetween extending from the first end to the second end, each protrusion abutting an adjacent surface.

16. The method of claim 15, comprising:
forming a plurality of inlets in the inner wall at the first end, the inlets in fluid communication with the cold channels for admitting the cool fluid stream therein; and
forming a plurality of outlets in the inner wall at the second end, the outlets in fluid communication with the cold channels for allowing the cool fluid stream to exit therefrom.

17. The method of claim 16, comprising:
joining every pair of surfaces defining a cold channel therebetween along the edges extending from the inner wall to the outer wall to form a fluid seal along each edge.

18. The method of claims 15, 16 or 17, wherein folding the sheet comprises:
folding the sheet so that the protrusions extending through a cold channel abut the adjacent surface.

19. The method of claim 18, wherein forming the protrusions comprises:
forming the protrusions with a generally frustoconical configuration.

20. The method of claims 15, 16 or 17, wherein folding the sheet comprises:
folding the sheet so that the protrusions extending through a hot channel each abut a like protrusion extending from the adjacent surface.

21. The method of claim 18, wherein forming the protrusions comprises:
forming the protrusions with a generally frustoconical configuration.

22. The method of claim 20, wherein folding the sheet comprises:
folding the sheet so that the protrusions extending through a hot channel each abut a like protrusion extending from the adjacent surface.

23. The method of claim 22, wherein the protrusions are stamped from the sheet in a generally frustoconical configuration.

24. The method of claim 16, wherein forming the protrusions comprises:
distributing the protrusions on each surface to promote even mass distribution of the fluid streams throughout the channels.

25. The method of claim 24, wherein forming the protrusions comprises:
distributing the protrusions extending through the cold channels with greater density near the inlets to promote increased cool fluid flow in the radial direction.

26. The method of claims 24 or 25, wherein forming the protrusions comprises:
forming the protrusions to extend from the surfaces to varying distances to promote even mass distribution of the fluid streams throughout the channels.

27. The method of claim 26, wherein forming the protrusions comprises:
forming the protrusions to define channels having varying cross-sectional areas to promote even mass distribution of the fluid streams throughout the channels.

28. The method of claim 27, wherein forming the protrusions comprises:
forming the protrusions to define the cold channels with radially increasing cross-sectional area.
